(19) United States
(12) Patent Application Publication
(10) Pub. No.: US 2018/0088497 A1
(43) Pub. Date: Mar. 29, 2018

(54) FIXING APPARATUS

(71) Applicant: CANON KABUSHIKI KAISHA, Tokyo (JP)

(72) Inventor: Koji Yasui, Yokohama-shi (JP)

(21) Appl. No.: 15/709,664

(22) Filed: Sep. 20, 2017

(30) Foreign Application Priority Data
Sep. 29, 2016 (JP) 2016-190942

(51) Int. Cl. G03G 15/20

(52) U.S. Cl. CPC G03G 15/2007; G03G 2215/2016

(57) ABSTRACT

A fixing apparatus, comprising: a cylindrical belt; a roller; a nip plate which comes into contact with an inner surface of the belt; a heater provided in a hollow portion of the belt, the heater radiating heat toward the nip plate and heating the belt via the nip plate; and a reflective member provided in the hollow portion of the belt, the reflective member covering the heater, the reflective member having a U-shaped cross section perpendicular to a direction of a rotational axis of the roller, an opening of the U-shaped cross section opposing the nip plate, wherein the reflective member includes a surface constituting a protruding portion which protrudes in a direction approaching the heater, the surface being configured so that heat radiated from the heater in a direction toward the reflective member is reflected in a direction that differs from a direction toward the heater.

### BACKGROUND OF THE INVENTION

### Field of the Invention

The present invention relates to a fixing apparatus which causes a developer image to be fixed to a recording medium.

### Description of the Related Art

In an electrophotographic system image forming apparatus such as a copier or a laser beam printer, a photosensitive drum is first charged by a charging roller and the charged photosensitive drum is then exposed by an exposing apparatus, whereby an electrostatic latent image is formed on the photosensitive drum. The electrostatic latent image formed on the photosensitive drum is developed as a toner image by a developing roller. Subsequently, the toner image formed on the photosensitive drum is transferred onto a recording material such as a sheet of paper by a transfer roller. In addition, the toner image transferred onto the recording material is fixed to the recording material by being subjected to heat and pressure by a fixing apparatus. In this manner, an image is formed on the recording material.

As a conventional fixing apparatus which causes a toner image transferred to a recording material to be fixed to the recording material, for example, a fixing apparatus using a halogen lamp as a heat source is known. The fixing apparatus is mainly provided with a cylindrical fixing belt (fixing film), a halogen lamp which is provided on an inner side of the fixing belt and which emits radiant heat, a nip plate to be heated by the halogen lamp, and a reflective plate which reflects the radiant heat toward the nip plate. The fixing apparatus is further provided with a stay which supports the nip plate, and a pressure roller which sandwiches the fixing belt with the nip plate by pushing the fixing belt toward the nip plate.

With the technique disclosed in Japanese Patent Application Laid-open No. 2013-114053, the reflective plate is given a shape of an inverted U when seen from a direction in which a fixing belt extends (an axial direction of a rotational center of a pressure roller). In addition, the reflective plate is arranged so as to cover a halogen lamp. Furthermore, in Japanese Patent Application Laid-open No. 2013-114053, while the reflective plate has an inverted U-shape, a side surface on an inner side of the reflective plate covering the halogen lamp is inclined so as to face a nip plate.

However, when the reflective plate has an inverted U-shape, radiant heat radiated in a direction of separation from the nip plate may be blocked by the halogen lamp and may fail to reach the nip plate even when the radiant heat is reflected by the reflective plate. Therefore, when the reflective plate has an inverted U-shape, there is a risk that the nip plate may not be sufficiently heated.

### SUMMARY OF THE INVENTION

A fixing apparatus, comprising:

a cylindrical belt;

a roller;

a nip plate which comes into contact with an inner surface of the belt, the nip plate forming a nip portion together with the roller via the belt;

a heater provided in a hollow portion of the belt, the heater radiating heat toward the nip plate and heating the belt via the nip plate; and

a reflective member provided in the hollow portion of the belt, the reflective member covering the heater at a distance from the heater, the reflective member having a U-shaped cross section perpendicular to a direction of a rotational axis of the roller, an opening of the U-shaped cross section opposing the nip plate,

wherein a recording material on which a toner image is formed is heated by heat of the belt while being transported by the nip portion, and the toner image is fixed to the recording material, and

wherein the reflective member includes a surface constituting a protruding portion which protrudes in a direction approaching the heater, the surface being configured so that heat radiated from the heater in a direction toward the reflective member is reflected in a direction that differs from a direction toward the heater.

Further features of the present invention will become apparent from the following description of exemplary embodiments (with reference to the attached drawings).

### BRIEF DESCRIPTION OF THE DRAWINGS

FIG. 1 is a schematic sectional view of an image forming apparatus according to a first embodiment;

FIG. 2 is a schematic sectional view of a fixing apparatus according to the first embodiment;

FIG. 3A is a sectional view of a reflective member according to the first embodiment, FIG. 3B is a perspective view of the reflective member, and FIG. 3C is a sectional view of a heating unit according to the first embodiment;

FIG. 4A is a sectional view simulating a shape of the reflective member according to the first embodiment in a simplified manner, FIG. 4B is a table showing a result of an experiment to determine whether radiant heat radiated from a halogen lamp 207 has reached a nip plate 206, and FIG. 4C is a sectional view showing a shape of a reflective member according to a comparative example;

FIG. 5A is a sectional view of a reflective member according to a second embodiment, FIG. 5B is a perspective view of the reflective member, and FIG. 5C is a sectional view of a heating unit according to the second embodiment; and

FIG. 6A is a diagram showing a shape of the reflective member according to the second embodiment, and FIG. 6B is a table showing a result of an experiment to determine whether radiant heat radiated from the halogen lamp 207 has reached the nip plate 206.

### DESCRIPTION OF THE EMBODIMENTS

### First Embodiment

Hereinafter, a description will be given, with reference to the drawings, of embodiments of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments.

<Image Forming Apparatus A>

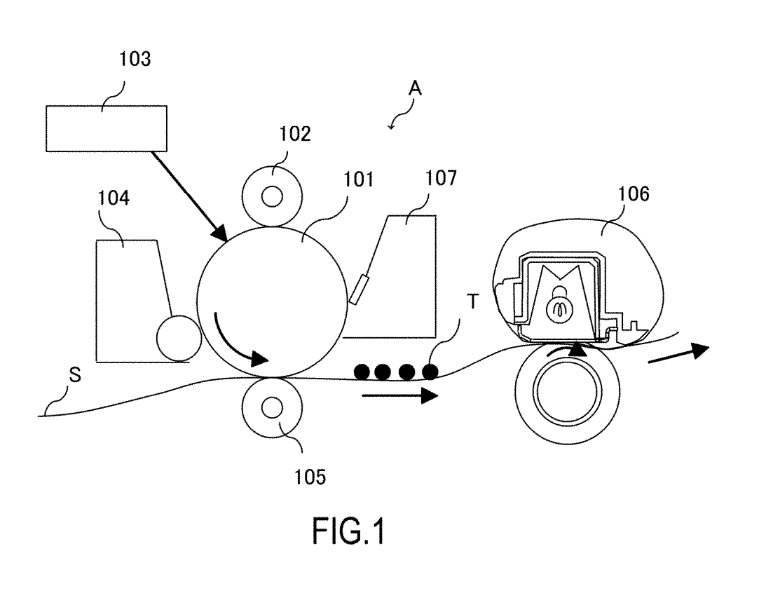

First, an image forming apparatus A will be described with reference to FIG. 1. FIG. 1 is a schematic sectional view of the image forming apparatus A according to the present embodiment. The image forming apparatus A is mounted with a fixing apparatus 106 using a halogen lamp 207 as a heat source. In addition, the image forming apparatus A is a laser beam printer utilizing an electrophotographic technique (an electrophotographic process). As shown in FIG. 1, in the image forming apparatus A, a charging roller 102, an exposing apparatus 103, a developing apparatus 104, and a transfer roller 105 are arranged around a photosensitive drum 101 along a rotation direction of the photosensitive drum 101. An electrostatic latent image is formed on a surface of the photosensitive drum 101 as the photosensitive drum 101 charged by the charging roller 102 is exposed by the exposing apparatus 103. In addition, the developing apparatus 104 uses toner to develop the electrostatic latent image formed on the photosensitive drum 101 as a toner image as a developer image, and the transfer roller 105 transfers the toner image formed on the photosensitive drum 101 onto a recording material S as a recording medium.

Specifically, the photosensitive drum 101 is rotationally driven at a prescribed peripheral velocity in a direction of an arrow (counterclockwise) in FIG. 1 and, first, a surface of the photosensitive drum 101 is uniformly charged to a prescribed polarity and potential by the charging roller 102. Next, laser light modulated in correspondence with image information is emitted from the exposing apparatus 103 to the surface of the uniformly charged photosensitive drum 101. Accordingly, an electrostatic latent image is formed on the surface of the photosensitive drum 101.

The electrostatic latent image formed on the photosensitive drum 101 is developed and visualized by the developing apparatus 104 as a toner image T. The visualized toner image T is transported toward the transfer roller 105 by the rotation of the photosensitive drum 101. Subsequently, the toner image T transported to the transfer roller 105 is transferred by the transfer roller 105 from the photosensitive drum 101 onto the recording material S. The recording material S onto which the toner image T has been transferred is separated from the photosensitive drum 101 and transported to the fixing apparatus 106.

Subsequently, the toner image is fixed to the recording material S as the toner image on the recording material S is subjected to heat and pressure by the fixing apparatus 106. The recording material S to which the toner image has been fixed is discharged to the outside of the image forming apparatus A. At this point, toner not having been transferred to the recording material S adheres to the surface of the photosensitive drum 101 after the toner image is transferred to the recording material S. The cleaning apparatus 107 cleans the photosensitive drum 101 by removing this toner. By repeating the process described above, images are repetitively formed on the recording material S. In this case, in the image forming apparatus A according to the present embodiment, a portion which forms the toner image will be referred to as an image forming portion.

<Fixing Apparatus 106>

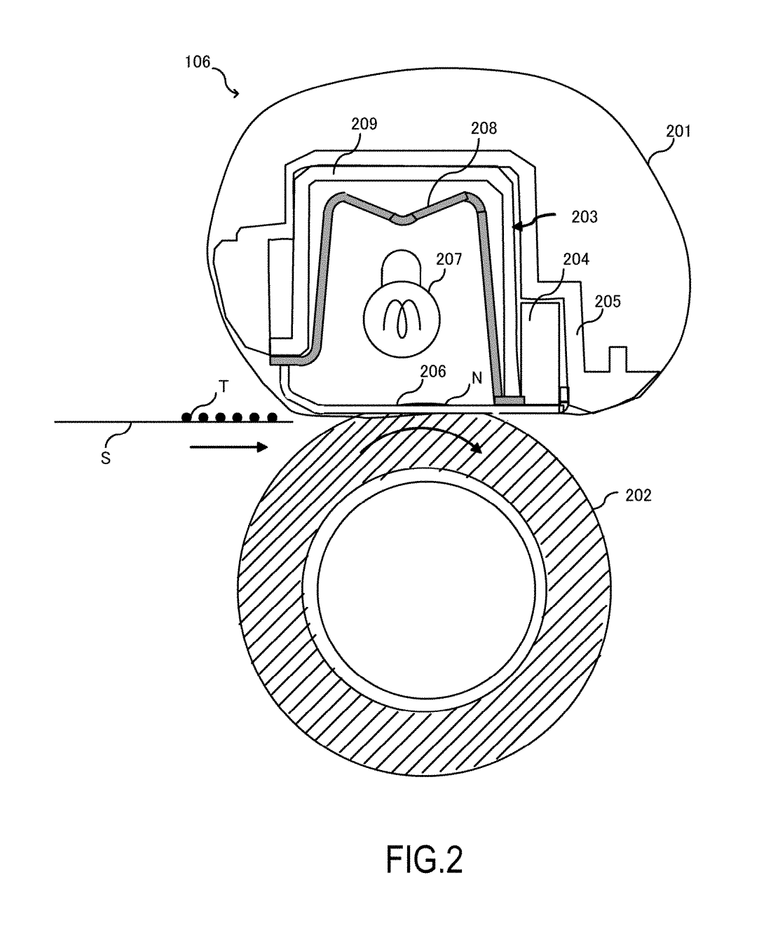

Next, a configuration of the fixing apparatus 106 will be described in detail with reference to FIG. 2. FIG. 2 is a schematic sectional view of the fixing apparatus 106 according to the present embodiment. Specifically, FIG. 2 is a schematic sectional view of the fixing apparatus 106 cut on a plane perpendicular to an axial line of a rotational center of a pressure roller 202. The fixing apparatus 106 includes a cylindrical fixing belt 201, a heating unit 203 which heats the fixing belt 201, the pressure roller 202 which sandwiches the fixing belt 201 with the heating unit 203, a temperature detecting member 204, and a guiding member 205.

The fixing belt 201 is heated by the heating unit 203, and by being rotated so as to follow the pressure roller 202, the fixing belt 201 rubs against a nip plate 206 as a heating member. Therefore, in the present embodiment, the fixing belt 201 is a belt with heat resistance and flexibility. In addition, the rotating fixing belt 201 is guided by the guiding member 205. The heating unit 203 is a unit which is arranged on an inner side of the fixing belt 201 and which heats the toner image T on the recording material S via the fixing belt 201. The heating unit 203 includes a halogen lamp 207, the nip plate 206, a reflective member 208, and a stay 209. Moreover, in the present embodiment, an axial line of a rotational center of the fixing belt 201 is approximately parallel to a direction in which the nip plate 206 and the reflective member 208 extends.

The pressure roller 202 is an elastically deformable member and is arranged at a position opposing the heating unit 203 across the fixing belt 201. In addition, in an elastically deformed state, the pressure roller 202 forms a nip portion N with the nip plate 206 in the heating unit 203. In other words, the nip plate 206 comes into contact with an inner surface of the fixing belt 201 and forms the nip portion N together with the pressure roller 202 via the fixing belt 201. Furthermore, the pressure roller 202 is rotationally driven by receiving a driving force from a motor (not shown) provided inside a housing of an apparatus main body of the image forming apparatus A. Accordingly, due to a friction force between the pressure roller 202 and the fixing belt 201 (or the recording material S), the fixing belt 201 is rotated so as to follow the pressure roller 202. In addition, the recording material S onto which the toner image T has been transferred is transported in a direction of an arrow in FIG. 2 between the heated fixing belt 201 and the pressure roller 202. In the process of the recording material S being transported between the fixing belt 201 and the pressure roller 202, the toner image on the recording material S is fixed by heat and pressure to the recording material S.

The temperature detecting member 204 is, for example, a known sensor such as a thermostat or a thermistor and detects temperature of the nip plate 206. In addition, the temperature detecting member 204 is configured to output detected temperature to a control apparatus (not shown) for controlling the fixing apparatus 106. The temperature detecting member 204 is provided singularly or in plurality on the nip plate 206 in the axial direction of the rotational center of the fixing belt 201.

The halogen lamp 207 is provided in a hollow portion of the fixing belt 201. The halogen lamp 207 emits radiant heat to heat the nip plate 206, and heats the fixing belt 201 via the nip plate 206. Toner on the recording material S is heated by the heat of the fixing belt 201 as the recording material is being transported by the nip portion N and is fixed to the recording material S. The halogen lamp 207 is arranged above the nip plate 206 at a prescribed distance from the reflective member 208. In addition, the nip plate 206 is a metallic plate-like member which receives radiant heat from the halogen lamp 207 and is arranged so that a lower surface of the nip plate 206 and an inner peripheral surface of the fixing belt 201 rub against each other. The nip plate 206 is formed by, for example, machining an aluminum plate or the like with higher thermal conductivity than the stay 209.

The reflective member 208 is a member which reflects radiant heat from the halogen lamp 207 toward the nip plate 206 and is arranged at a prescribed interval from the halogen lamp 207 so as to cover the halogen lamp 207. Specifically, the reflective member 208 covers the halogen lamp 207 so that the halogen lamp 207 is exposed with respect to the nip plate 206. In other words, the reflective member 208 has a U-shaped cross section perpendicular to the rotational axis of the pressure roller 202 and is provided such that an opening of the U-shaped cross section opposes the nip plate 206. In addition, the halogen lamp 207 is covered (enclosed) by the reflective member 208 and the nip plate 206. Moreover, the radiant heat radiated from the halogen lamp 207 either directly reaches the nip plate 206 or indirectly reaches the nip plate 206 after being reflected by an inner surface of the reflective member 208. Providing the fixing apparatus 106 with the reflective member 208 enables the radiant heat from the halogen lamp 207 to be efficiently utilized to quickly heat the nip plate 206 and the fixing belt 201.

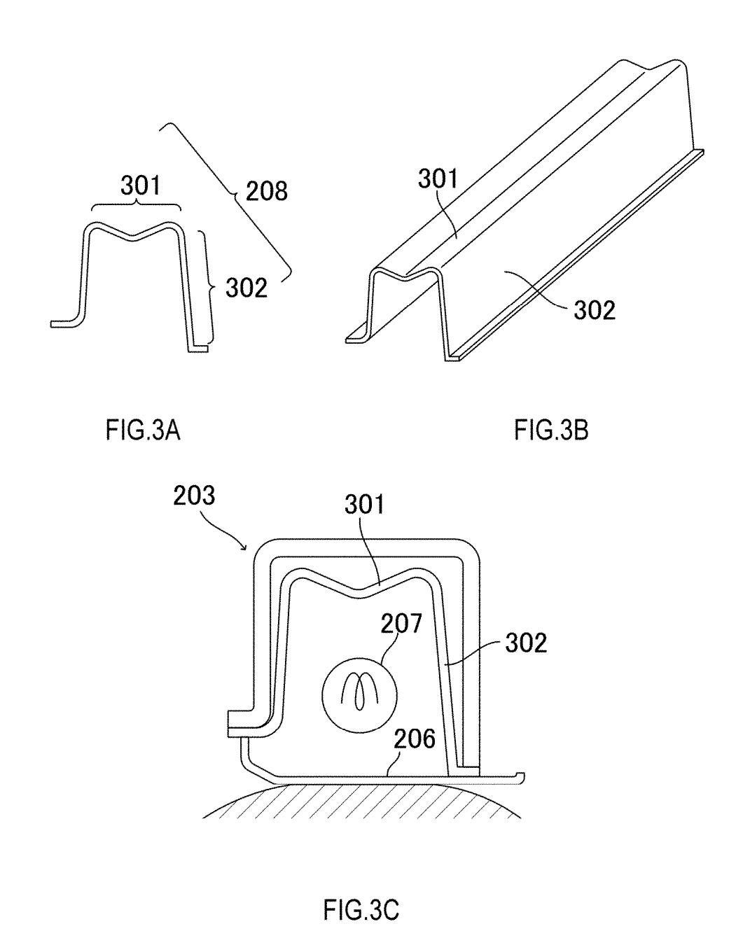

FIGS. 3A, 3B and 3C are diagrams showing the reflective member 208 according to the present embodiment. Specifically, FIG. 3A is a sectional view of the reflective member 208 cut on a plane perpendicular to the axial line of the rotational center of the pressure roller 202. In addition, FIG. 3B is a perspective view of the reflective member 208, and FIG. 3C is a sectional view of the heating unit 203 cut on a plane perpendicular to the axial line of the rotational center of the pressure roller 202.

In the present embodiment, as the reflective member 208, an aluminum plate or the like with high reflectance of infrared light and far-infrared light is used. As shown in FIG. 3C, a reflective surface of the reflective member 208 positioned on a side opposite to the nip plate 206 with respect to the halogen lamp 207 includes a reflective surface 301 being a first inner surface (a first surface) constituting a protruding portion which protrudes toward the nip plate 206. The reflective surface 301 is arranged on a side opposite to the nip plate 206 across the halogen lamp 207. In addition, a reflective surface 302 being a second inner surface is inclined such that an inner surface thereof faces a side of the nip plate 206 (which corresponds to a side of a heating member). The reflective surface 302 constitutes inner surfaces of two leg portions of the U-shaped cross section. Specifically, the reflective surface 302 includes two faces opposing each other across the nip plate 206, and a first face and a second face of the two faces are inclined so as to approach each other as a distance from the nip plate 206 increases. Furthermore, in the present embodiment, due to the reflective surface 301 being provided on the reflective member 208, radiant heat radiated from the halogen lamp 207 in a direction opposite to a direction toward the nip plate 206, in other words in a direction toward the reflective member 208, is reflected by the reflective surface 301 and proceeds in a direction that differs from a direction toward the halogen lamp 207. The radiant heat reflected by the reflective surface 301 is then reflected by the reflective surface 302 in the present embodiment and reaches the nip plate 206. Specifically, a part of the reflective surface 301 overlaps with the halogen lamp 207 when seen from the side of the nip plate 206. In addition, a part of the reflective surface 301 reflects radiant heat so that at least a part of radiant heat radiated in a direction toward a center of the halogen lamp 207 from a center of a heating position (a position at which the nip plate 206 heats the recording material S) does not reach the halogen lamp 207. On the other hand, the reflective surface 302 is a surface which is reached by the radiant heat reflected by the reflective surface 301 and which reflects, toward the nip plate 206, the radiant heat reflected by the reflective surface 301. Furthermore, the reflective surface 301 is a protruding portion which protrudes toward the inside of the reflective member 208 and which is inclined with a portion overlapping a center of the halogen lamp 207 as a vertex when seen from the side of the nip plate 206.

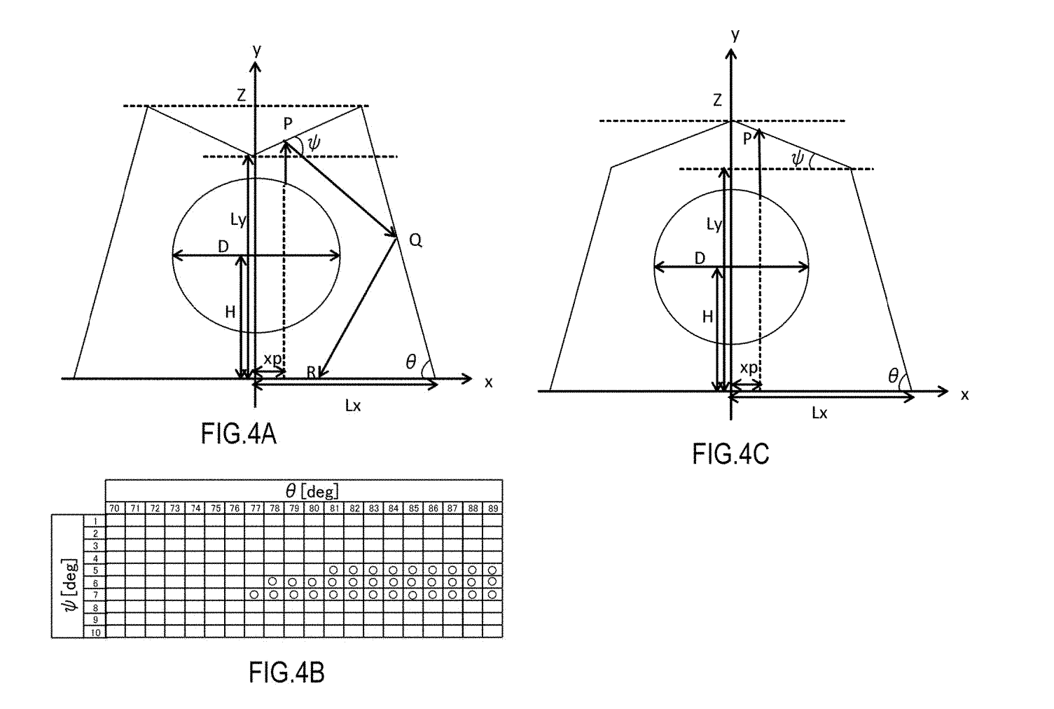

FIG. 4 is a diagram showing a shape of the reflective member 208 according to the present embodiment. Specifically, FIG. 4 represents a sectional view of the fixing apparatus 106 cut on a plane perpendicular to the axial line of the rotational center of the fixing belt 201. FIG. 4A is a diagram showing a shape of the reflective member 208 according to the present embodiment, and FIG. 4B represents a result of an experiment to determine whether radiant heat radiated from the halogen lamp 207 has reached the nip plate 206. FIG. 4C is a diagram showing a shape of the reflective member 208 according to a comparative example. In order to confirm an effect of the present embodiment, the experiment used a model simulating the shape of the reflective member 208 in a simplified manner as shown in FIG. 4A. In addition, it was confirmed whether radiant heat radiated toward a side opposite to the nip plate 206 reaches the nip plate 206.

In this case, in FIGS. 4A and 4C, a distance H denotes a distance from an upper surface of the nip plate 206 to the center of the halogen lamp 207 and a diameter D denotes a diameter of the halogen lamp 207. In addition, a distance Lx denotes a distance from the center of the halogen lamp 207 to an intersection (a contact portion) of the reflective surface 302 and the nip plate 206 in an x direction shown in FIGS. 4A and 4C. Furthermore, a distance Ly denotes a distance between the vertex of the reflective surface 301 and the upper surface of the nip plate 206 in a y direction shown in FIGS. 4A and 4C. An angle θ as a second angle denotes an angle formed by the upper surface of the nip plate 206 and the reflective surface 302, and an angle ψ as a first angle denotes an angle formed by the upper surface of the nip plate 206 and the reflective surface 301. In addition, the angle ψ is an angle formed by the reflective surface 301 and a plane perpendicular to a direction in which the halogen lamp 207 is viewed from the side of the nip plate 206, and is an angle set so that radiant heat reflected by the reflective surface 301 is reflected toward the reflective surface 302. On the other hand, the angle θ is an angle formed by the reflective surface 302 and a plane perpendicular to the direction in which the halogen lamp 207 is viewed from the side of the nip plate 206, and is an angle set so that radiant heat reflected by the reflective surface 302 after being reflected by the reflective surface 301 is reflected toward the nip plate 206.

Furthermore, a point P denotes a position on the reflective surface 301 reached by radiant heat radiated in the y direction from the halogen lamp 207, and a point Q denotes a position on the reflective surface 302 reached by radiant heat reflected by the reflective surface 301. In addition, a point R denotes a position on the nip plate 206 reached by radiant heat reflected by the reflective surface 302.

In the experiment, a case was hypothesized in which radiant heat is radiated in a direction perpendicular to the upper surface of the nip plate 206 from a position separated by a distance xp (in the x direction) from the center of the halogen lamp 207. In the present experiment, the distance Lx was set to 7 mm, the distance Ly to 13 mm, the distance H to 7 mm, the diameter D to 8 mm, and the distance xp to 3 mm. In addition, a determination was made as to whether the radiant heat from the halogen lamp 207 reached the nip plate 206 when the angle θ and the angle ψ were respectively varied from 1° to 89°.

As described earlier, FIG. 4B represents a part of the result of the present experiment. In FIG. 4B, combinations of the angles for which the radiant heat from the halogen lamp 207 reaches the nip plate 206 are denoted by ο. Specifically, an experiment result of ο is obtained when the angle ψ ranges from 5° to 7° and the angle θ ranges from 81° to 89°, when the angle ψ ranges from 6° to 7° and the angle θ ranges from 78° to 80°, and when the angle ψ is 7° and the angle θ is 77°. Moreover, when the reflective surface 301 is parallel to the nip plate 206, radiant heat radiated in a direction (y direction) perpendicular to the nip plate 206 is reflected by the reflective surface 301 and ends up returning to the halogen lamp. Therefore, the radiant heat radiated from the halogen lamp 207 does not reach the nip plate 206. In the present embodiment, the angle ψ and the angle θ are set so that a straight line passing through the point P and the point Q and a straight line passing through the point Q and the point R do not overlap with the halogen lamp 207.

In addition, as shown in FIG. 4C, a case where the reflective surface 301 protrudes in an opposite direction to the present embodiment was considered as a comparative example. In FIG. 4C, a height Z (y direction) of the reflective member 208 is equal to a height Z (y direction) of the reflective member 208 when ψ is set to 10° in FIG. 4A. As parameters in the comparative example, the same parameters as the present embodiment (distance Lx=7 mm, distance Ly=13 mm, distance H=7 mm, diameter D=8 mm, and distance xp=3 mm) are used. As a result of performing the experiment according to the comparative example, the radiant heat radiated from the halogen lamp 207 in the y direction did not reach the nip plate 206. Due to this experiment result, in the present embodiment, it was found that including the reflective surface 301 in the reflective member 208 enables radiant heat from the halogen lamp 207 to be efficiently collected on the nip plate 206. Accordingly, the nip plate 206 can be heated in an efficient manner.

As described above, in the present embodiment, the reflective member 208 includes the reflective surface 301 which is arranged on a side opposite to the nip plate 206 across the halogen lamp 207. The reflective surface 301 is shaped so as to protrude toward the nip plate 206. In addition, the reflective surface 301 reflects, in a direction which differs from a direction toward the halogen lamp 207, at least a part of radiant heat radiated in a direction opposite to a direction from the side of the halogen lamp 207 (which corresponds to a side of a heat source) toward a side of the nip plate 206. Furthermore, the reflective member 208 includes the reflective surface 302 which is a surface reached by the radiant heat reflected by the reflective surface 301 and which reflects, toward the nip plate 206, the radiant heat reflected by the reflective surface 301. Therefore, since radiant heat radiated toward the side opposite to the nip plate 206 reaches the nip plate 206, the nip plate 206 can be heated in an efficient manner. As a result, the time required to heat the nip plate 206 can be reduced.

### Second Embodiment

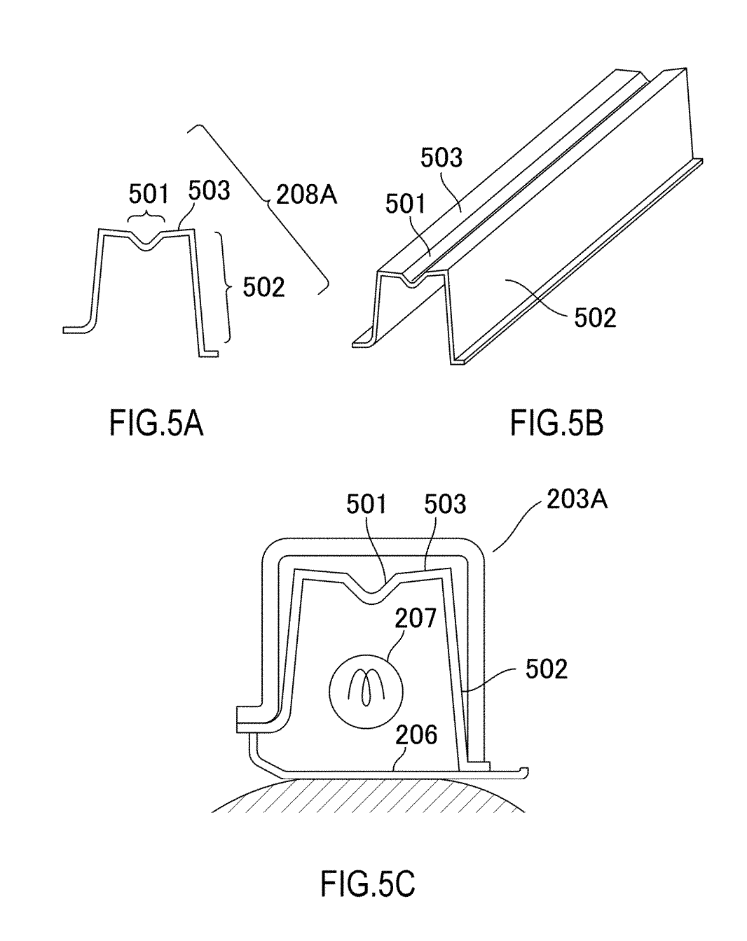

Next, a second embodiment will be described. In the second embodiment, portions having the same functions as the first embodiment will be denoted by the same reference characters and a description thereof will be omitted. FIGS. 5A, 5B, and 5C are schematic diagrams showing a reflective member 208A according to the present embodiment. Specifically, FIG. 5A is a sectional view of the reflective member 208A cut on a plane perpendicular to the axial line of the rotational center of the pressure roller 202. In addition, FIG. 5B is a perspective view of the reflective member 208A, and FIG. 5C is a sectional view of a heating unit 203A cut on a plane perpendicular to the axial line of the rotational center of the pressure roller 202.

In the present embodiment, the reflective member 208A is configured as shown in FIG. 5. As shown in FIG. 5C, in the present embodiment, the reflective member 208A arranged on a side opposite to the nip plate 206 with respect to the halogen lamp 207 in a similar manner to the first embodiment includes a protruding reflective surface 501 being a first inner surface which protrudes toward the nip plate 206. The protruding reflective surface 501 is arranged on a side opposite to the nip plate 206 across the halogen lamp 207. In addition, the protruding reflective surface 501 is a surface which overlaps with the halogen lamp 207 when seen from the side of the nip plate 206. Furthermore, a part of the protruding reflective surface 501 reflects radiant heat so that radiant heat radiated in a direction toward a center of the halogen lamp 207 from a center of a heating position (a position at which the nip plate 206 heats the recording material S) does not reach the halogen lamp 207. On the other hand, a reflective upper surface 503 as a second inner surface is a surface which is reached by the radiant heat reflected by the protruding reflective surface 501 and which reflects the radiant heat toward a reflective side surface 502 as a third inner surface so that the radiant heat reflected by the protruding reflective surface 501 does not return to the halogen lamp 207. In addition, the reflective side surface 502 is an inner surface which is reached by the radiant heat reflected by the reflective upper surface 503 and which reflects, toward the nip plate 206, the radiant heat reflected by the reflective upper surface 503. Moreover, radiant heat is reflected at a point P′ on the protruding reflective surface 501, at a point S′ on the reflective upper surface 503, and at a point Q′ on the reflective side surface 502. In addition, radiant heat reflected by the reflective side surface 502 reaches a point R′ on the nip plate 206. In the present embodiment, in a similar manner to the first embodiment, an angle ψ, an angle φ, and an angle θ are set so that a straight line passing through the point P′ and the point S′, a straight line passing through the point S′ and the point Q′, and a straight line passing through the point Q′ and the point R′ do not overlap with the halogen lamp 207.

In addition, the reflective side surface 502 is inclined so that, the further in the y direction, the closer the reflective surface 502 is to the halogen lamp 207. Furthermore, the reflective upper surface 503 is inclined at an angle which differs from an inclination angle (an angle with respect to the upper surface of the nip plate 206) of the protruding reflective surface 501. Moreover, in the present embodiment, it was confirmed whether radiant heat radiated from the halogen lamp 207 in a direction (y direction) perpendicular to the nip plate 206 reaches the nip plate 206.

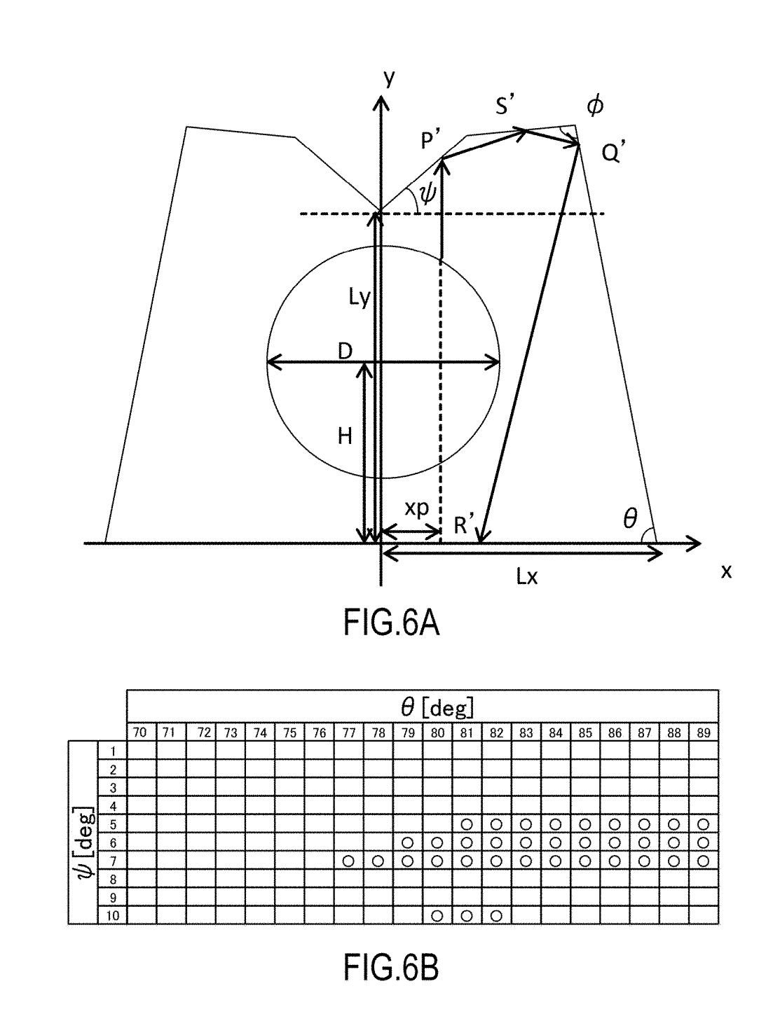

FIG. 6 is a diagram showing a shape of the reflective member 208A according to the second embodiment. Specifically, FIG. 6A is a diagram showing a shape of the reflective member 208A according to the present embodiment, and FIG. 6B represents a result of an experiment to determine whether radiant heat radiated from the halogen lamp 207 has reached the nip plate 206. In the present embodiment, the angle ψ as a first angle is an angle formed by the protruding reflective surface 501 and a plane perpendicular to a direction in which the halogen lamp 207 is viewed from the side of the nip plate 206, and is an angle set so that radiant heat reflected by the protruding reflective surface 501 is reflected toward the reflective upper surface 503. In addition, the angle φ as a second angle is an angle formed by the reflective upper surface 503 and the reflective side surface 502 and is an angle set so that radiant heat reflected by the protruding reflective surface 501 is reflected toward the reflective side surface 502. Furthermore, the angle θ as a third angle is an angle formed by the reflective side surface 502 and a plane perpendicular to the direction in which the halogen lamp 207 is viewed from the side of the nip plate 206, and is an angle set so that radiant heat reflected by the reflective side surface 502 is reflected toward the nip plate 206. Moreover, in a similar manner to the first embodiment, the protruding reflective surface 501 is a protruding portion which protrudes toward the inside of the reflective member 208A and which is inclined with a portion overlapping with the center of the halogen lamp 207 as a vertex when seen from the side of the nip plate 206.

Moreover, in an experiment performed with respect to the present embodiment, parameters and values of parameters used in the experiment were set the same as the experiment performed with respect to the first embodiment (distance Lx=7 mm, distance Ly=13 mm, distance H=7 mm, diameter D=8 mm, and distance xp=3 mm). However, in the present embodiment, the angle φ formed by the reflective side surface 502 and the reflective upper surface 503 was set to 90°. As shown in FIG. 6B, due to the reflective member 208A including the protruding reflective surface 501 and the reflective upper surface 503, the present embodiment similarly enables the nip plate 206 to be heated in an efficient manner. Specifically, an experiment result of ο is obtained when the angle ψ ranges from 5° to 7°, the angle φ is 90°, and the angle θ ranges from 81° to 89°, and when the angle ψ ranges from 6° to 7°, the angle φ is 90°, and the angle θ ranges from 79° to 80°. In addition, an experiment result of ο is obtained when the angle ψ is 7°, the angle φ is 90°, and the angle θ ranges from 77° to 78°, and when the angle ψ is 10°, the angle φ is 90°, and the angle θ ranges from 80° to 82°. As described above, in the present embodiment, radiant heat radiated toward the side opposite to the nip plate 206 can reach the nip plate 206 and the nip plate 206 can be efficiently heated in a similar manner to the first embodiment.

Moreover, in the respective embodiments, the inner surface of the reflective member (208, 208A) need not be a flat surface. For example, the inner surface of the reflective member may be a curved surface.

In addition, in the respective embodiments, a heat source of the fixing apparatus 106 need not necessarily be the halogen lamp 207. The heat source is not particularly limited as long as the heat source is capable of radiating radiant heat.

Furthermore, in the respective embodiments, the nip plate 206 need not have a flat shape. For example, the nip plate 206 may have a bent (curved) shape.

Moreover, in the respective embodiments, the halogen lamp 207 may be approximately completely covered by the reflective member and the nip plate 206. In this case, the nip plate 206 can be heated more efficiently. In the respective embodiments, an inside of the reflective member need not necessarily be exposed at ends in the longitudinal direction of the reflective member.

In addition, in the respective embodiments, the reflective member has two (first embodiment) or four (second embodiment) surfaces opposing the nip plate 206. However, configurations are not necessarily limited to the above. For example, the reflective member may have three, five, or six surfaces opposing the nip plate 206.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-190942, filed on Sep. 29, 2016 which is hereby incorporated by reference herein in its entirety.

What is claimed is:

1. A fixing apparatus, comprising:
a cylindrical belt;
a roller;
a nip plate which comes into contact with an inner surface of the belt, the nip plate forming a nip portion together with the roller via the belt;
a heater provided in a hollow portion of the belt, the heater radiating heat toward the nip plate and heating the belt via the nip plate; and
a reflective member provided in the hollow portion of the belt, the reflective member covering the heater at a distance from the heater, the reflective member having a U-shaped cross section perpendicular to a direction of a rotational axis of the roller, an opening of the U-shaped cross section opposing the nip plate,
wherein a recording material on which a toner image is formed is heated by heat of the belt while being transported by the nip portion, and the toner image is fixed to the recording material, and
wherein the reflective member includes a surface constituting a protruding portion which protrudes in a direction approaching the heater, the surface being configured so that heat radiated from the heater in a direction toward the reflective member is reflected in a direction that differs from a direction toward the heater.

2. The fixing apparatus according to claim 1, wherein, when the surface is a first surface, the reflective member includes a second surface provided so as to reflect, toward the nip plate, heat reflected by the first surface.

3. The fixing apparatus according to claim 1, wherein the protruding portion is provided on a top surface opposing the opening of the U-shaped cross section of the reflective member.

4. The fixing apparatus according to claim 3, wherein the protruding portion has a V-shape in the U-shaped cross section.

5. The fixing apparatus according to claim 2, wherein the second surface of the reflective member is an inner surface of one of two leg portions of the U-shaped cross section.
